(19) United States
(12) Patent Application Publication
(10) Pub. No.: US 2022/0274831 A1
(43) Pub. Date: Sep. 1, 2022

(54) METHANE CONVERSION TO HYDROGEN EMPLOYING A STAGED SHOCK COMPRESSION WAVE REFORMER

(71) Applicant: New Wave Hydrogen, Inc., Calgary (CA)

(72) Inventors: Pejman Akbari, Pasadena, CA (US); Colin D. Copeland, North Pitt Meadows (CA); Sfefan Tüchler, Bath (GB); Mark Davidson, Gainesville, FL (US)

(73) Assignee: New Wave Hydrogen, Inc., Calgary (CA)

(21) Appl. No.: 17/683,102

(22) Filed: Feb. 28, 2022

Related U.S. Application Data
(60) Provisional application No. 63/155,007, filed on Mar. 1, 2021.

(51) Int. Cl. C01B 3/34; B01J 3/08; B01J 19/18; B01J 19/00

(52) U.S. Cl. CPC C01B 3/346; B01J 3/08; B01J 19/1806; B01J 19/0053; C01B 2203/0833; C01B 2203/1241; B01J 2219/00761

(57) ABSTRACT

An improved hydrogen generation system comprising a multi-port wave reformer in which shock and expansion waves are created in a manner causing head-on colliding shock waves and multi-stage compression where reacting gases within a six port wave reformer are mtiply heated and compressed to thermally crack or decompose one or more fuel sources, such as hydrocarbon fuels, to generate a fuel product containing hydrogen.

### CROSS-REFERENCE TO CO-PENDING APPLICATIONS

The present invention is related to the following co-pending U.S. Patent applications, which are all commonly owned with the present application, the entire contents of each being hereby incorporated herein by reference thereto and claims the priority benefit of U.S. Provisional Application No. 63/155,007, filed Mar. 1, 2021; as well as to U.S. patent application Ser. No. 17/307,621, filed on May 4, 201; U.S. patent application Ser. No. 17/545,771, filed on Dec. 8, 2021; U.S. patent application Ser. No. 17/569,659, filed on Jan. 6, 2022; and to U.S. Pat. No. 11,220,428, dated Jan. 11, 2022.

### BACKGROUND OF THE INVENTION

### Field of the Invention

The present invention relates generally to hydrogen generation systems that include a wave reformer to thermally crack or decompose fuel sources, such as hydrocarbon fuels, to produce a fuel product containing hydrogen, and to methods of operating such systems.

### Description of Related Art

Fossil fuels have drastically been affecting the environment for many years, and are considered as being prime contributions to global warming. Hydrogen, as a carbon-free energy carrier, will play a critical role in reducing or even eliminating greenhouse gas emissions. Additionally, hydrogen shows a broad range of existing and potential applications including, but not limited to, the electricity, transport, propulsion, and heating industries. Currently green hydrogen can be produced from renewable energy sources (e.g. solar or wind power) or by electrolysis powered by input energy [See, Fang, Z., Smith, R. L., and Qi, X., “Production of Hydrogen from Renewable Resources,” 2015, Springer]. Alternatively, hydrogen is conventionally produced from fossil fuels like reforming of natural gas [See, Mondal, K. C., Chandran, S. R., “Evaluation of the Economic Impact of Hydrogen Production by Methane Decomposition with Steam Reforming of Methane Process,” Int J Hydrogen Energy, 2014; Vol. 39, No. 18, pp: 9670-9674]. In particular, steam methane reforming is a classic industrial method for hydrogen production. In this well-developed approach, methane and hydrogen are heated until they react. The process yields hydrogen and carbon dioxide. Therefore, this method not only continuously produces harmful carbon dioxide in large quantities, but it also requires input energy which often uses hydrocarbon fuels, further contributing to emission problem. Additionally, access to water resources is needed to produce steam which prohibits this technology in regions or places where there is a water shortage.

Considering the drawbacks of steam methane reforming, the decomposition of methane from natural gas provides a more environmentally friendly and efficient process. In this process, referred to as methane pyrolysis or methane cracking, methane is decomposed into its elements: hydrogen and solid carbon (CH₄→C+2 H₂). The governing reaction is endothermic and the necessary energy input should be provided from different sources of energy. The main characteristic of this process is the absence of oxygen, which eliminates carbon dioxide and CO by-products, making the process very attractive. Additionally, no water is consumed, and the produced carbon can be marketed and used in a variety of areas, or it can be securely stored for future use. Different methods of methane decomposition processes have been developed including direct thermal cracking at very high temperature, catalyzed thermal decarbonization, and plasma-torch driven methane pyrolysis [See, Muradov, N., “Low to Near-Zero CO₂ Production of Hydrogen from Fossil Fuels: Status and perspectives,” Int J Hydrogen Energy, 2017, Vol. 42, No. 20, pp: 14058-88]. A limited number of these processes have been commercialized. These conversion processes differ in relation to the reactor type, the use of a catalyst, and the source of process-related energy. Among these methods, the direct thermal cracking is exclusively based on the heating of methane up to temperatures in which the kinetics of the reaction produces very high conversions in a reasonable time. To achieve these requirements, high temperatures are needed which demand costly energy inputs.

To efficiently achieve those high temperatures required for direct thermal methane decomposition, a wave reformer utilizing shock heating has been proposed in a previously published patent application US2018/0215615, entitled “Hydrocarbon Waver Reformer and Methods of Use,” by New Wave Hydrogen (formerly Standing Wave Reformer) Inc., which is incorporated herein by reference in its entirety. The invention overcomes some of disadvantages of the prior techniques by employing unsteady waves?? to produce large temperature levels very rapidly with lower energy consumption per unit mass of product.

### DESCRIPTION OF PRESENTLY PREFERRED EXAMPLES OF THE INVENTION BRIEF DESCRIPTION OF FIGURES

The invention is better understood by reading the following detailed description with reference to the accompanying drawings in which:

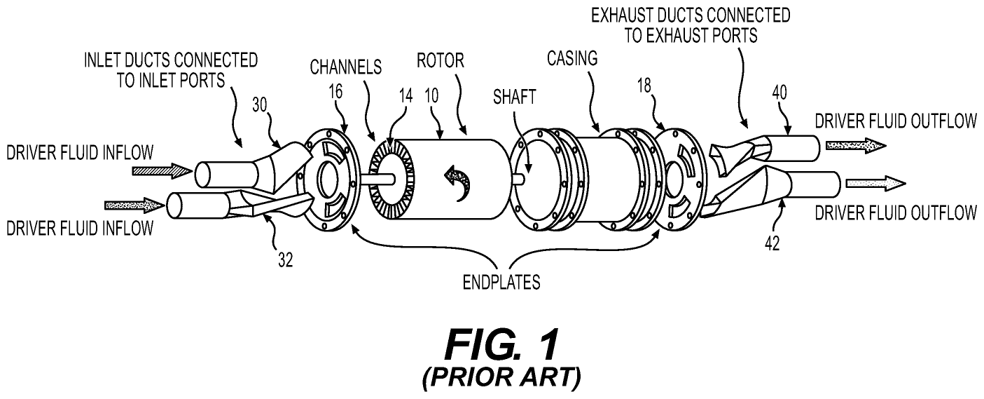

FIG. 1 (prior art) shows an expanded view of the four-port wave rotor;

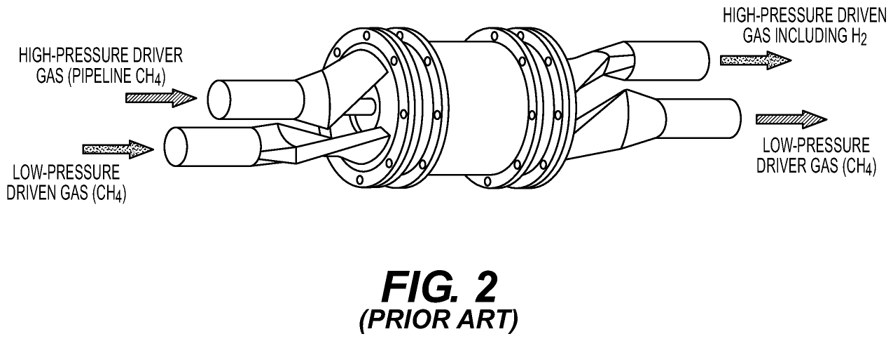

FIG. 2 (prior art) is a four-port wave reformer can be used to decompose methane into hydrogen and carbon black;

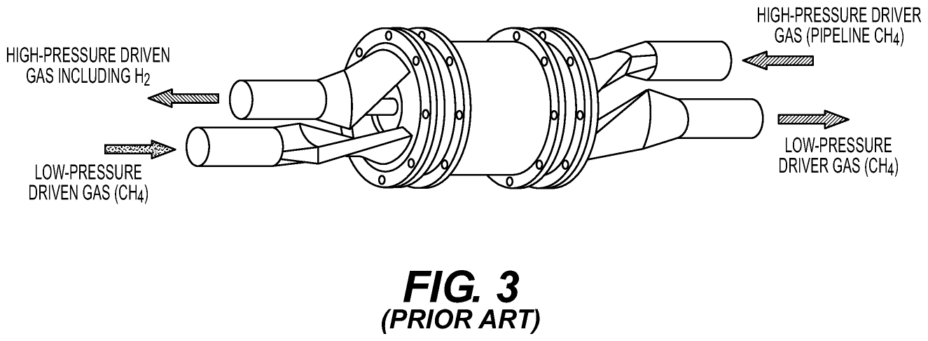

FIG. 3 (prior art) shows a reverse-flow wave reformer;

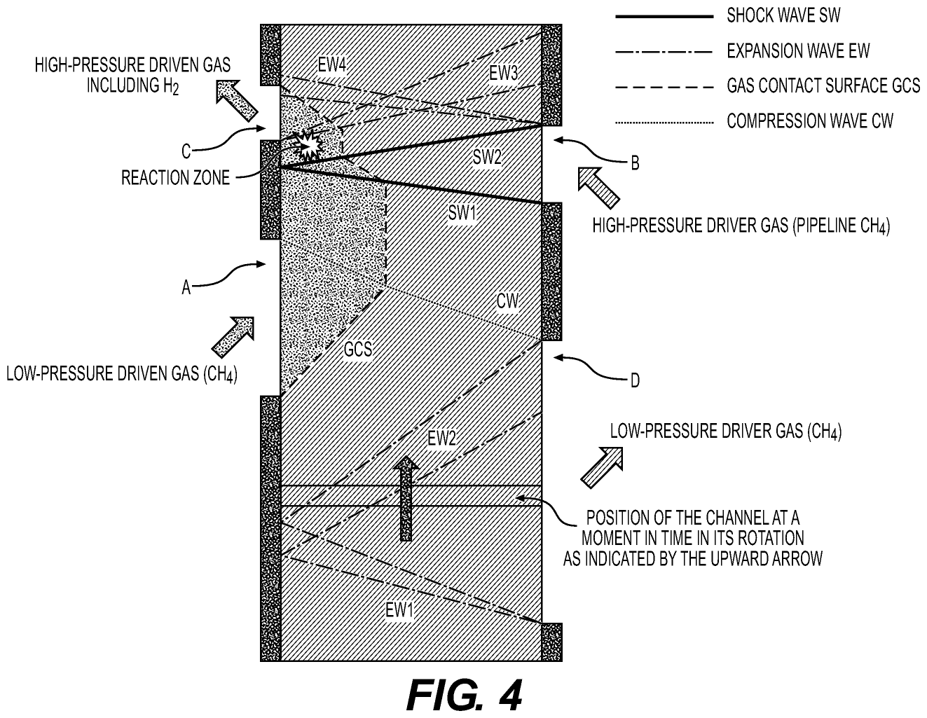

FIG. 4 shows a wave diagram showing the inner working principles and the unsteady flow process within a wave reformer;

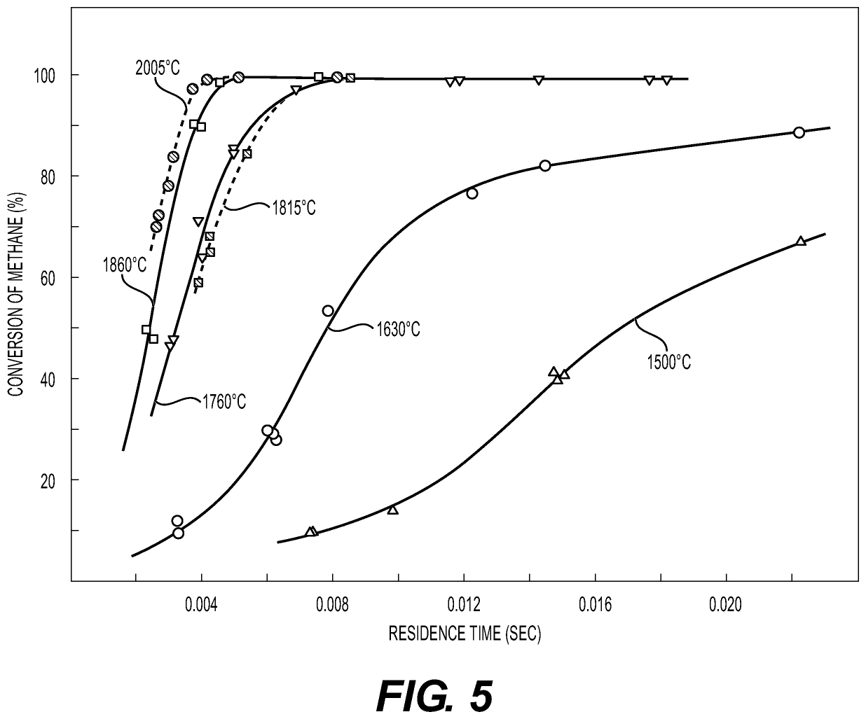

FIG. 5 shows the conversion of methane at different temperatures;

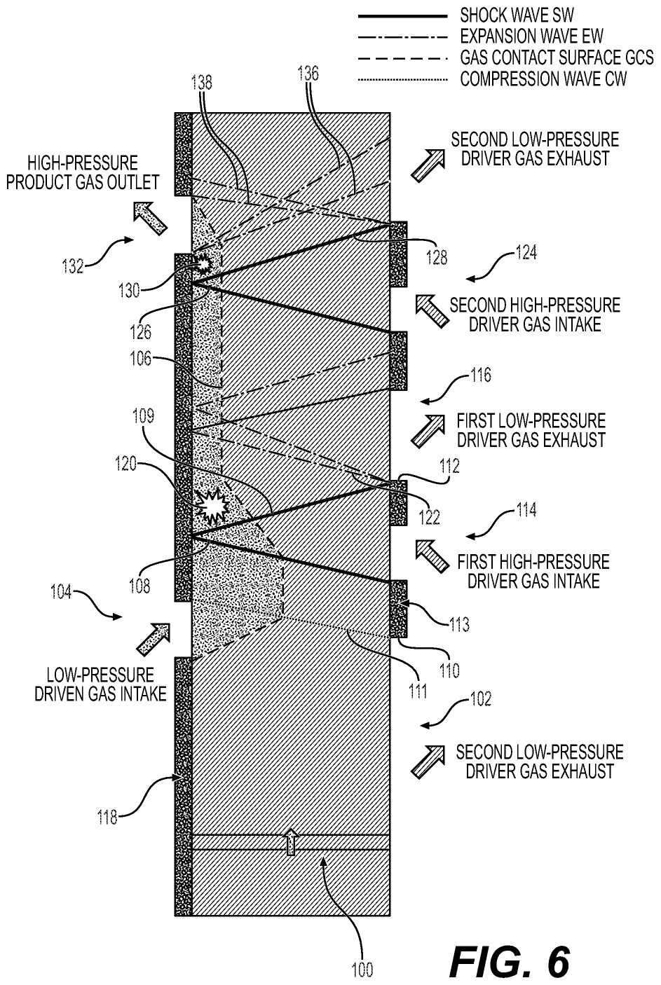

FIG. 6 schematically shows a new wave cycle employing multiple driver ports where at least two separate driver gas ports are used; and

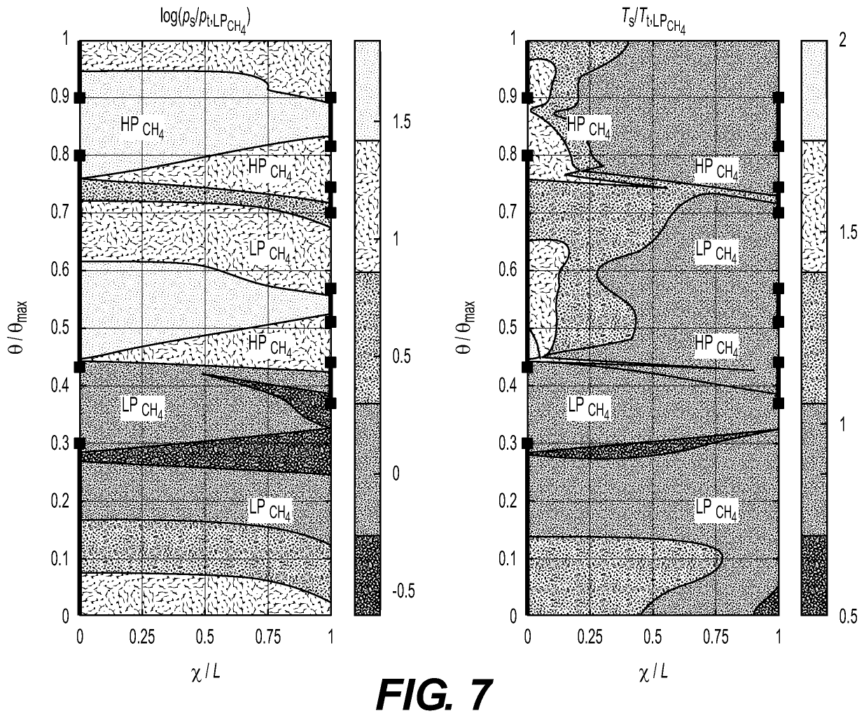

FIG. 7 shows a numerical modeling of a NWH₂ wave reformer incorporating the wave cycle details of this invention.

### DETAILED DESCRIPTION OF THE INVENTION

Wave rotors are a direct energy exchange device that utilize one-dimensional pressure wave action for the transfer of mechanical energy between two compressible fluid flows which are at different pressure levels. [See, Akbari, P., Nalim, M. R., and Muller, N., “A Review of Wave Rotor Technology and Its Applications” ASME Journal of Engineering for Gas Turbines and Power, 2006, Vol. 128, No. 4, pp. 717-735]. As shown in FIG. 1, a wave rotor 10 typically consists of a cylindrical rotor 12 with an array of long axial channels 14 that are arranged uniformly around the rotor's periphery. The rotor 12 spins between two stationary endplates, 16 and 18, through which the flow enters and exists. Each endplate has a number of ports 20 to accommodate the incoming and outgoing fluids. Each of the rotating channels 14 operates similar to an individual shock tube. The entry and exit endplates, 16 and 18, function as the valves and resemble the partitions or diaphragms of the conventional form of shock tube, forming a serios of unsteady compression and expansion waves within the channels as they periodically rotate past the inlet and exit ports 20 and regions of closed end walls. To generate compression waves, the channels 14 are exposed to a high-pressure port through which a driver gas which enters the channels 14 and compresses the gas within it. To generate expansion waves, the channels 14 are exposed to low-pressure port and the gas in the channels 14 discharges. Rotational motion of the drum 10 gives precise control of the wave processes. By using a large number of channels on the fast-spinning drum, the pulsed process occurring in a single shock tube is translated to a nearly continuous process [See, Rose, P. H., “Potential Applications of Wave Machinery to Energy and Chemical Processes,” Proceedings of the 12th International Symposium on Shock Tubes and Waves, 1979, pp. 3-30]. Therefore, the wave rotor can be considered as the steady flow analogue of the single pulse shock tube. Steady rotation of the drum establishes unsteady but periodic flow processes within the rotating passages and nearly steady flow in the inlet and outlet ports. In a typical design, the channels 14 are extend axially and arranged parallel to the drive shaft driven, for example, by an electric motor (or belt driven). In such a configuration, the only power input to the rotor 10 is that necessary to overcome bearing friction. However, if the tubes are not axial (e.g. curved channels), net power can be even extracted from the rotor similar to that of a turbine in addition to the work exchange between the fluid streams. [See, Richler, S., Copeland, C. D., “Validation of a Numerical Quasi-One-Dimensional Model for Wave Rotor Turbines with Curved Channels,” J. of Eng. for Gas Turbines and Power, 2020, Vol. 142, No. 2, pp: 021017].

A variety of wave rotor configurations have been developed for different applications. The number and azimuthal location of the ports distinguish them for different purposes. For instance, four-port, five-port, and nine-port wave rotors have been investigated for gas turbine engine topping applications [See, Akbari, P., Nalim, M. R., and Muller, N., “A Review of Wave Rotor Technology and Its Applications” ASME Journal of Engineering for Gas Turbines and Power, 2006, Vol. 128, No. 4, pp. 717-735]. A four-port pressure exchange wave rotor is briefly discussed below to illustrate how it operates. A schematic of a four-port wave rotor is shown in FIG. 1 which uses two inlet ports, 30 and 32, and two outlet ports 40 and 42, respectively. Gaps between the rotor 10 and the faces of endplates 16 and 18 are exaggerated for clarity, but in practice to minimize gas leakage the gap is kept very small, or the endplates may use sealing material that contact the rotor. The driven (low-pressure fluid) enters the rotor 10 from an inlet port 32 at one end of the rotor. The rotor channels 14 filled with the driven gas are rotated to the driver (high-pressure fluid) gas inlet port 30. Due to the pressure difference between the driver and driven gases, the high-pressure driver gas is forced into the channels. This initiates shock waves that pass through the channels and compresses the lower pressure driven fluid already in the channels. The driver gas must be compressed sufficiently so that the required shock strengths are generated within the wave reactor. Continuous rotation of the drum places the channels between the closed portions of the end walls 16 and 18 that bring the channel flow to rest. The now energized driven fluid leaves the channels through the first outlet port 40 at the opposite end assisted by generated expansion waves. The de-energized driver gas is then scavenged out of the drum through the secondary outlet port 42 by rotation, and the cycle then repeats itself. By carefully selecting port locations and their dimensions, a significant and efficient transfer of energy can be obtained between flows in the connected ducts with minor mixing effects at the gas interfaces. The net effect is an increase in stagnation pressure and temperature of the compressing gas and a decrease in stagnation pressure and temperature for the expanding gas, similar to turbo compressors and turbines. Here, gas dynamic waves are replaced by mechanical blades for energy exchange between the fluids.

Direct pyrolysis of hydrocarbons in wave reformers have been proposed by New Wave Hydrogen, Inc. In such a wave rotor-based fuel reformer, the energy (pressure) embodied in a pressurized natural gas pipeline (e.g. methane) is used to initiate shock waves in the reformer used for heating a hydrocarbon fuel and decomposing due to use of rapid shock compression. The wave reformer functions as an efficient energy exchanger where the high-pressure driver gas leverages the pressure of the driven gas (e.g. methane fuel), resulting in a rapid heating the driven gas to temperatures sufficient to crack fuel into hydrogen and black carbon as a solid product. This novel technology offers optimal utilization of natural gas, as one of the largest energy reserves on earth, to produce clean hydrogen without emitting carbon dioxide with lower energy consumption than existing hydrocarbon reforming methods.

FIG. 2 represents how a four-port wave reformer can be used to decompose methane into hydrogen and carbon black. In the four-port wave rotor shown in FIGS. 1 and 2, inlet ports are located on one side of the rotor, and outlet ports are located on the other. This is knowns a through-flow configuration. Alternatively, it is possible to design a reverse-flow machine where each gas stream enters and leaves the channel from the same end. These two configurations may provide identical overall performance, but they differ substantially in their internal processes. FIG. 3 shows a reverse-flow wave reformer.

A wave diagram, as shown in FIG. 4, will assist one to understand the inner working principles and the unsteady flow process within wave reformers. Wave diagrams are helpful to predict flow fields occurring in the channels and generate new cycles or to guide a designer quickly to a choice between various wave cycle designs. A wave diagram is viewed as an x-t (distance-time) which is a time-history of the flow in any single wave rotor passage as it moves through the wave rotor cycle. Since the same things occur in each of the rotor channels, the operation can best be understood by explaining what happens in one of the rotor channels during one complete revolution of the drum. Wave diagrams can be viewed as an instantaneous snapshot of the flow in the entire rotor with the circular motion of the rotor channels is represented by straight translatory motion (i.e. unwrapped view of the rotor). FIG. 4 schematically illustrates an unwrapped demonstration of a reverse-flow wave reformer with the rotor channel moving upward or vertically in the figure. The wave diagram portrays the annular arrangement of the inlet and outlet ports, solid walls reflecting the endplates, the wave fronts, and gas interfaces during each phase of the cycle which is useful in visualizing the processes which occur in a single cycle of a wave machine. It should be understood that the top of each wave diagram is looped around and joined to the bottom of the diagram, i.e. each wave cycle is repetitive. The vertical solid lines on each side of the channels represent the stationary end walls that establish the portion of the cycle over which the inlet and outlet ports are closed. The diagonal lines are the propagation lines (trajectories) of the waves and contact surfaces (boundaries between the fluids). Wave interactions at interfaces are ignored. The light gray represents the low-pressure driven gas (e.g. methane) and the darker gray represents the driver gas (e.g. pipeline natural gas). Each cycle consists of two inflow ports, A and B, where ingress of the fresh driver (B) and driven fluids (A) are fed into the moving channels, and two outflow ports, C and D, where the energized-driven gas (C) and de-energized driver gas (D) are discharged from the rotor channels. For fuel reforming application, a pre-heated hydrocarbon fuel (e.g. methane) will be chosen as the reacting gas, and pre-heated pressurized natural gas supply will be selected as the driver gas. The pressure ratio between the reactant gas and driver gas is a factor determining the strength of the shock wave generated. The required pressure ratio will depend upon the reaction temperature desired to be produced for the processing of a particular reactant gas. The process can be made more efficient by either pre-heating the driver gas or pre-heating the driver gas, reducing the pressure ratio required for the process. By pre-heating these gases, the increment of temperature rise in the reactant gas that must be produced by action of the shock wave to reach the elevated temperature at which the particular chemical reaction is intended to take place will be smaller.

In the following, the events occurring in a channel during one complete cycle will be described and it will be described in detail how shock and expansion waves are neatly employed to transfer the energy directly between the gases and generate hydrogen in the wave reformer. In FIG. 4, the cycle begins in the bottom part of the wave diagram where the flow within the channel consists of a large part of the fresh driver gas and some residual of the driver gas from a previous cycle. As the right end of the channel opens to the relatively low-pressure outlet port D, an expansion fan EW1 originates from the leading edge of the outlet port D and propagates into the channel, expanding and discharging the used driver gas to the surrounding. The expansion fan EW1 reflects off the left wall as EW2 and further reduces the pressure and temperature in the channel This draws fresh low-pressure driven gas, the reacting gas (light gray), into the channel when the inlet port A starts to open on the left side of the channel This entering reacting (driven) gas is separated from the residual (driver) gas (darker gray) by a contact surface shown at GCS. When the reflected expansion fan EW2 reaches the upper edge of exhaust port D, it slows the outflow and reflects back to the left as a compression wave CW. The compression wave CW travels toward the inlet port A stopping the channel flow. As the compression wave CW reaches the upper corner of the inlet port A, that port closes gradually. At this moment, the channel is closed at both ends filled with the reacting gas separated from the residual gas by a contact surface GCS denoted by a vertical line, and the channel fluid is at rest relative to the rotor. Through continuous rotation of the rotor, the fresh driver gas entry port B opens, and the channel right end is exposed to the high-pressure driver gas. Because the driver gas pressure is higher than the gas pressure in the channel, a shock wave SW1 is triggered starting from the lower corner of the high-pressure inlet port B. The shock wave SW1 runs to the left through the channel and causes an abrupt rise of pressure and temperature inside the channel Behind the shock wave SW1, the compressed fresh driven gas, residual gas, and the driver gas are separated through two gas interfaces along CGS. As the shock wave SW1 reaches the end of the channel, a reflected shock wave SW2 is generated, propagating to the right back into the channel which compresses the channel fluid further. Passage of the shock waves SW1 and SW2 through the reactant gas raises it to reaction temperature, thus thermal decomposition of the fuel occurs behind the reflected wave in a hot reaction zone. When the secondary outlet port C opens, the doubled-compressed reacting product (e.g. hydrogen and any intermediaries) is expelled from the channel by an expansion fan EW3 generated at the lower corner of the outlet port C propagating downstream toward the inlet endplate. The closure of the inlet port B is timed with the arrival of the reflected shock wave SW2. At this moment, another expansion fan EW4 originates from the upper corner of the inlet port B and propagates to the left toward the other end of the channel which eventually brings the channel flow to rest. When the expansion fan EW4 reaches the end of the channel, the outlet port C closes and the flow in the rotor channels stops and contains the fresh driver gas plus some residual gas. At this point, the channel will go through the same cycle process. The described sequence of events occurs successively in each of the reactor channels as the drum is rotated so that a continuous supply of processed gas is discharged into the outlet port.

Thermal methane cracking without the presence of a catalyst can take place above 1000° C. with sufficient residence time. Nevertheless, at this temperature, the conversion and kinetics of the reaction are rather low. Studies show that around 1200° C., the full conversion of methane into hydrogen is theoretically feasible, however it strongly depends on the kinetics of the reaction in an experimental set up. Temperatures above 1400-1500° C. are realistic for practical implementations [See, Abanades, A., “Low Carbon Production of Hydrogen by Methane Decarbonization,” Chapter 6 in Production of Hydrogen from Renewable Resources, 2015, Springer, pp: 149-177; and Holmen, A., Olsvik, O., and Rokstad, O. A., “Pyrolysis of Natural Gas: Chemistry and Process Concepts,” Fuel Process. Technol., 1995, Vol. 42, pp. 249-267]. The hydrocarbons are thermodynamically unstable at such high temperatures and the only products would be carbon and hydrogen if the reaction time is long enough.

FIG. 5, which is from Holmen, A., Olsvik, O., and Rokstad, O. A., “Pyrolysis of Natural Gas: Chemistry and Process Concepts,” Fuel Process. Technol., 1995, Vol. 42, pp. 249-267, shows the conversion of methane at different temperatures. For example, FIG. 5 shows that for a 40% methane conversation, about 3 millisecond residence time would be required at 1860° C. temperature. Meanwhile, at a lower temperature of 1500° C., a longer reaction time of about 15 milliseconds is required to obtain the same yield of methane. In a wave reformer, temperatures in excess of 2000° C. can be generated behind the reflected shock wave, but in practice the peak temperature in the reaction zone decreases sharply to a lower value because the methane-pyrolysis reaction is endothermic. Thus, at a lower temperature a longer residence time is required in the device to maintain maximum yield of hydrogen. The residence time in the flow diagram of a wave reformer shown in FIG. 4 starts from the arrival of the primary shock wave to the channel end wall and its reflection from the rigid wall. It only lasts before the opening of the processed gas outlet port when the processed gas is rapidly cooled by the expansion waves and expelled or scavenged from the downstream end of the channel Ideally, this reaction time can be changed by adjusting the rotor speed, the rotor length, and port conditions. However, the rotor speed and the position and width of the ports are already selected with the speed of the propagating waves to avoid all undesired flow phenomena in the device, leading to a favorable well-tuned wave pattern [See, U.S. Pat. No. 2,902,337, Glick, H. S., Hertzberg, A., Squire, W., and Wetherston, R., 1959, “Methods for Heating and Cooling Gases and Apparatus Therefor,”]. Therefore, it is beneficial to increase the residence time when the reaction at a peak temperature can be prolonged. This invention introduces several wave cycles that promote longer residence time hydrogen formation for a higher fuel-to-hydrogen conversion. All these cycle present techniques to maintain compressed reacting gas within the channel long enough.

FIG. 6 sets forth schematically a new wave cycle employing multiple driver ports where at least two separate driver gas ports are used. In this arrangement the endplates create a six-port wave reformer and are provided with three inflow ports and three outflow ports. This new six-port wave reformer allows the reactant gas to enter and leave at the same end of the rotor (on the left-hand side of the diagram) via inlet and exhaust ports, but driver gases are being fed into and expelled out of the rotor twice through their corresponding entry and exhaust ports at the opposite end of the rotor (on the right-hand side of the diagram.

The cycle starts from the bottom of FIG. 6 when the channel 100 becomes filled with driver gas from a previous cycle is opened to a second low-pressure outlet or exhaust port 102. Then, fresh low pressure driven reactant gas enters the channel 100 via a low-pressure driven gas inlet or intake port 104 on the left side of the channel 100. This fresh low pressure driven gas is separated from the driver gas by a gas contact surface 106 shown as a dotted line. When the second low-pressure driver gas exhaust port 102 closes, a primary hammer shock wave 111 is generated from the lower edge 110 of the exhaust port 102, in a right side endplate or end wall 113, that travels toward the low-pressure driven gas inlet port 104 stopping the channel flow. At this moment the channel 100 is partially filled with the fresh reactant gas and the remaining portion of the driver gas in the channel (e.g. residual gas). By opening a first high-pressure driver gas port 114, the first high-pressure driver gas compresses the residual driver gas and the fresh reactant gas through the primary shock wave 108 and the reflected shock wave 109 in the first stage. The creation of these shock waves causes a heating process that provides suitable reaction conditions in a first reaction zone 120 behind the reflected shock wave 109 and adjacent the left side endplate or end wall 118. The first driver gas starts to expel from the channel's right end 113 by opening another driver gas exhaust port 116.

Expansion waves 122 generated at the upper corner 112 adjacent the downstream end propagate upstream toward the hot reaction zone 120 facilitating a scavenging action for the driver gas. These expansion waves 122 pass through the heated reactant gas and reflect at the closed upstream end. By closing the first low-pressure driver gas exhaust port 116, the first driver gas is scavenged and the heated reactant gas adjacent to the left endplate is carried out by the channels. After allowing the appropriate time for carrying out the heated reactant gas, the next (second) phase of compression starts. Similar to the shock-heating process, the right end of the channel 100 is exposed to the opening of a second high-pressure driver gas port 124 is input compressing the reactant and the residual driver gas a second time from the first compression stage against end wall 118. The high pressure gas coining in via inlet port 124 can be from a source that can be from the same as a source of the first high pressure gas inflowing through intake port 114, or from a separate or second source, with the same or different properties as the first high pressure drive gas and its source. Another set of incidence shock wave 126 and reflected shock waves 128 creates a secondary reaction zone 130 forming behind the secondary reflected shock wave 128. The processed gas leaves the channel 100 through a high -pressure product gas outlet port 132 placed at the left endplate 118. The high-pressure product gas outlet port 132 remains open long enough to complete the scavenging of the processed gas. This scavenging is also facilitated by an expansion wave 136 generated at the lower corner of the outlet port 132. At the right end of the channel, another exhaust port, the second low-pressure driver gas exhaust port 102 opens and an expansion fan 138 originates from the leading edge of the exhaust port and propagates upstream into the channel 100 expanding and discharging the secondary driver gas to the surrounding and the cycle then repeats.

As shown in FIG. 6, this invention introduces a new wave 6-port cycle that adds benefits over previous 4-port wave cycles in terms of peak temperature and reaction residence time within the channel. In this present 6-port wave cycle approach, the driver gases are fed twice through their corresponding spaced apart inlet ports 114 and 116, respectively, thereby doubling the compressing the driven low pressure gas input through inlet port 104 against the reflecting end wall 118, before that driven gas is exhausted via exhaust port 132, where the reaction zones 120 and 130 occur next to end wall 118 which itself provides a greater circumferential extent than, for example, the left side end wall in FIG. 4. This allows the reaction products to remain for a longer time in the reactor instead of expanding the gas as in the previous cycles. This, in turn produces a higher fuel-to-hydrogen conversion. Meanwhile, by using a staged-driver compression, where at least two driver inlet gas ports are used, the peak temperature is elevated, which also results in a higher rate of hydrogen production.

FIG. 7 represents a numerical modeling of a NWH₂ wave reformer incorporating the wave cycle details discussed above. Preheated methane is used as the driver and the driven gases. The terms “HP” and “LP” refer to high pressure and low pressure, respectively. The color contours show non-dimensional pressure and temperature, in a representative channel, as a function of time (vertical axis) and position (horizontal) over one complete cycle of operation. A color scale bar is provided to the immediate right of each contour plot. Axial distance is non-dimensionalized by channel length, L. Vertical axis represented by angular displacement is non-dimensionalized by maximum angular displacement, θmax, which is 360 degrees. The pressure and temperature are non-dimensionalized by the driven inlet port stagnation state properties, respectively.

Starting from the temperature plot, it shows the inward movement of the contact interface between cooler gas in the channels and preheated fresh reactant gas received at the inlet port at non-dimensional time 0.3. Along with the pressure plot, a region of high-pressure is seen after opening the first driver inlet port at non-dimensional time 0.45 due to compression by the incidence shock wave. A more significant higher-pressure high-temperature region near to the left endplate is also seen where a reflected shock wave is created. The temperature plot also indicates a region of high temperature at non-dimensional times between 0.45-0.62 with a peak temperature approximately three times higher that of the driven inlet port stagnation temperature. This peak temperature and channel pressure decrease considerably after opening the corresponding outlet port at non-dimensional time about 0.58 due to the gas expansion. The temperature plot also shows the second stage of compression starts at an initial temperature higher than that in the low-pressure methane intake port, indicating the first stage of compression preheats the channel gas prior to shock heating in the second stage. The processed gas leaves the channel from its corresponding outlet port, which opens at non-dimensional time 0.8 (left), at a relatively high temperature and high pressure. On the pressure plot, the incidence and reflected shock wave trajectories are clearly seen in both stages of compression. For stability reasons, in these preliminary simulations, the partial opening/closing feature of the code was not activated, i.e. the channel is considered to open and close instantaneously as it passes through the ports. Thus, the incidence shock waves are created only a short time before the driver intake ports open. The depression of pressure due to the generated expansion fans are seen at non-dimensional times about 0.58 and 0.9 (right) for the first and second stages of compression, respectively.

When introducing elements of various aspects of the present invention or embodiments thereof, the articles “a,” “an,” “the” and “said” are intended to mean that there are one or more of the elements, unless stated otherwise. The terms “comprising,” “including” and “having,” and their derivatives, are intended to be open-ended terms that specify the presence of the stated features, elements, components, groups, and/or steps, but do not exclude the presence of other unstated features, elements, components, groups, and/or steps and mean that there may be additional features, elements, components, groups, and/or steps other than those listed. Moreover, the use of “top” and “bottom,” “front” and “rear,” “above,” and “below” and variations thereof and other terms of orientation are made for convenience but does not require any particular orientation of the components. The terms of degree such as “substantially,” “about” and “approximate,” and any derivatives, as used herein mean a reasonable amount of deviation of the modified term such that the end result is not significantly changed. For example, these terms can be construed as including a deviation of at least +/−5% of the modified term if this deviation would not negate the meaning of the word it modifies.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. A hydrogen generation system comprising a multi-port wave reformer in which shock and expansion waves are created in a manner causing multi-stage shock compression where reacting gases remain for a longer time within the multi-port wave reformer and are heated and compressed to thermally crack or decompose one or more fuel sources, such as hydrocarbon fuels, to generate a fuel product containing hydrogen.

2. The hydrogen generation system as in claim 1 wherein the multi-port wave reformer includes six ports.

3. The hydrogen system as in claim 1 wherein the multi-port wave reformer includes four ports on one end wall and at two ports on an opposing end wall.

4. The hydrogen system as in claim 3 wherein the end wall including two ports has a greater circumferential area than said one end wall.

5. The hydrogen system as in claim 3 wherein the four ports include two spaced apart inlet ports alternating with two spaced apart exhaust ports through which driver gases are fed into and expelled out of the wave rotor twice through their corresponding spaced apart inlet and exhaust ports.

6. A six-port wave reformer having a plurality of inlet ports and exhaust ports provided in end walls thereof, with an inlet port spaced from an exhaust port on one side of the wave reformer that collectively allows a driven reactant gas to enter and leave from one side of the wave reformer, and an additional plurality of inlet ports and exhaust ports on an opposite side of the wave reformer, including two spaced apart inlet ports alternating with two spaced apart exhaust ports through which driver gases are fed into and expelled out of the wave rotor.

7. The six port wave reformer as in claim 6 wherein the driver gases are fed twice through their corresponding spaced apart inlet and exhaust ports

8. The six port wave reformer as in claim 6 wherein the end wall containing the inlet port spaced from an exhaust port on one side of the wave reformer provides a greater circumferential area than the opposing side of the wave reformer.
